(19) United States
(12) Patent Application Publication
(10) Pub. No.: US 2009/0124599 A1
(43) Pub. Date: May 14, 2009

(54) Fungicidal Mixtures

(75) Inventors: Markus Gewehr, Kastellaun (DE); Reinherd Stierl, Freinsheim (DE); Matthis Niedenbrück, Limburgerhof (DE); Udo Hünger, Lambsheim (DE)

Correspondence Address: BRINKS, HOFER, GILSON & LIONE, P.O. BOX 1340, MORRISVILLE, NC, 27560, US

(73) Assignee: Basf Aktiengesellschaft, Ludwigshafen (DE)

(21) Appl. No.: 11/793,793

(22) PCT Filed: Dec. 21, 2005
(86) PCT No.: PCT/EP05/13780

§ 371 Date: Jun. 21, 2007

(30) Foreign Application Priority Data
Dec. 23, 2004 (DE) 10 2004 063 321.5

(51) Int. Cl. A01N 43/00; A01N 43/64; A01N 43/16; A01N 43/90; A01N 37/12; A01N 37/44

(52) U.S. Cl. 514/217.06; 514/259.31; 514/261.1; 514/534; 514/383; 514/457

(57) ABSTRACT

Fungicidal mixtures comprising, as active components
1) the strobilurin derivative of the formula I,

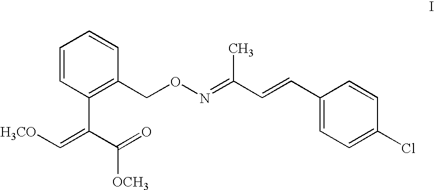

and
2) at least one active compound II selected from the group of heterocyclic compounds
   in a synergistically effective amount, methods for controlling harmful fungi using mixtures of the compound I with active compounds II, the use of the compound I with active compounds II for preparing such mixtures and compositions comprising these mixtures.

The present invention relates to fungicidal mixtures comprising, as active components,
1) the strobilurin derivative of the formula I,

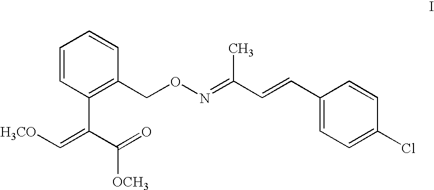

and
2) at least one active compound II selected from the group of heterocyclic compounds:
   fluazinam, pyrifenox,
   bupirimate, cyprodinil, fenarimol, ferimzone, mepanipyrim, nuarimol, pyrimethanil,
   triforine,
   fenpiclonil, fludioxonil,
   aldimorph, dodemorph, fenpropimorph, tridemorph,
   fenpropidin,
   iprodione, procymidone, vinclozolin,
   famoxadone, fenamidone, octhilinone, probenazole,
   5-chloro-7-(4-methylpiperidin-1-yl)-6-(2,4,6-trifluorophenyl)[1,2,4]triazolo[1,5-a]pyrimidine,
   anilazine, diclomezine, pyroquilon, proquinazid, tricyclazole,
   2-butoxy-6-iodo-3-propylchromen-4-one,
   acibenzolar-S-methyl, captafol, captan, dazomet, folpet, fenoxanil, quinoxyfen,
   N,N-dimethyl-3-(3-bromo-6-fluoro-2-methylindol-1-sulfonyl)[1,2,4]triazole-1-sulfonamide
   and
   5-chloro-6-phenyl-7-heterocyclylaminotriazolopyrimidines of the formula II-A,

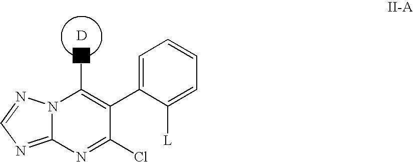

in which
   D together with the nitrogen atom form a pyrrolidine, piperidine or azepine ring, which rings are unsubstituted or substituted by one or two methyl groups or by one ethyl, propyl or butyl group; and
   L is methyl, fluorine or chlorine;
      in a synergistically effective amount.

Moreover, the invention relates to a method for controlling harmful fungi using mixtures of the compound I with active compounds II, to the use of the compound I with active compounds II for preparing such mixtures and to compositions comprising these mixtures.

The strobilurin derivative, referred to above as component 1, of the formula I, methyl 2-{2-[3-(4-chlorophenyl)-1-methylallylideneaminooxymethyl]phenyl}-3-methoxyacrylate, its preparation and its action against harmful fungi are known from the literature (EP-A 936 213, common name: enestroburin).

The active compounds II, mentioned above as component 2, their preparation and their action against harmful fungi are generally known (cf.: http://www.hclrss.demon.co.uk/index.html); they are commercially available.

Fluazinam, 3-chloro-N-[3-chloro-2,6-dinitro-4-(trifluoromethyl)phenyl]-5-(trifluoromethyl)-2-pyridineamine (The Pesticide Manual, publ. The British Crop Protection Council, 10th ed. (1995), p. 474);
pyrifenox, 1-(2,4-dichlorophenyl)-2-(3-pyridinyl)ethanone O-methyloxime (EP-A 49 854) bupirimate, 5-butyl-2-(ethylamino)-6-methyl-4-pyrimidinyidimethylsulfamate (GB 14 00 710),
cyprodinil, (4-cyclopropyl-6-methylpyrimidin-2-yl)phenylamine (EP-A 310 550);
fenarimol, α-(2-chlorophenyl)-α-(4-chlorophenyl)-5-pyrimidinemethanol (GB 12 18 623), ferimzone, (Z)-2′-methylacetophenone 4,6-dimethylpyrimidin-2-ylhydrazone;
mepanipyrim, (4-methyl-6-prop-1-ynylpyrimidin-2-yl)phenylamine (EP-A 224 339);
nuarimol, α-(2-chlorophenyl)-α-(4-fluorophenyl)-5-pyrimidinemethanol (GB 12 18 623);
pyrimethanil, 4,6-dimethylpyrimidin-2-yl)phenylamine (DD-A 151 404);
triforine, N,N′-{piperazine-1,4-diylbis[(trichloromethyl)methylene]}diformamide (DE 19 01 421);
fenpiclonil, 4-(2,3-dichlorophenyl)-1H-pyrrole-3-carbonitrile (Proc. 1988 Br. Crop Prot. Conf.—Pests Dis., Vol. 1, p. 65);
fludioxonil, 4-(2,2-difluorobenzo[1,3]dioxol-4-yl)-1H-pyrrol-3-carbonitrile (The Pesticide Manual, publ. The British Crop Protection Council, 10th ed. (1995), p. 482);
aldimorph, 4-alkyl-2,5(or 2,6)-dimethylmorpholine comprising 65-75% of 2,6-dimethylmorpholine and 25-35% of 2,5-dimethylmorpholine, more than 85% being 4-dodecyl-2,5(or 2,6)-dimethylmorpholine and where “alkyl” may also be octyl, decyl, tetradecyl or hexadecyl and where the cis/trans ratio is 1:1;
dodemorph, 4-cyclododecyl-2,6-dimethylmorpholine (DE 1198125), fenpropimorph, (RS)-cis-4-[3-(4-tert-butylphenyl)-2-methylpropyl]-2,6-dimethylmorpholine (DE 27 52 096),
tridemorph, 2,6-dimethyl-4-tridecylmorpholine (DE 11 64 152),
fenpropidin, (RS)-1-[3-(4-tert-butylphenyl)-2-methylpropyl]piperidine (DE 27 52 096) iprodione, N-isopropyl-3-(3,5-dichlorophenyl)-2,4-dioxoimidazolidine-1-carboxamide (GB 13 12 536);
procymidone, N-(3,5-dichlorophenyl)-1,2-dimethylcyclopropane-1,2-dicarboximide (U.S. Pat. No. 3,903,090);
vinclozolin, 3-(3,5-dichlorophenyl)-5-methyl-5-vinyloxazolidine-2,4-dione (DE-A 22 07 576);
famoxadone, (RS)-3-anilino-5-methyl-5-(4-phenoxyphenyl)-1,3-oxazolidine-2,4-dione;
fenamidone, (S)-1-anilino-4-methyl-2-methylthio-4-phenylimidazolin-5-one;
octhilinone,
probenazole, 3-allyloxy-1,2-benzothiazole 1,1-dioxide [CAS RN 27605-76-1];
anilazine, 4,6-dichloro-N-(2-chlorophenyl)-1,3,5-triazine-2-amine (U.S. Pat. No. 2,720,480);
diclomezine, 6-(3,5-dichlorophenyl-p-tolyl)pyridazin-3(2H)-one;
pyroquilon, 1,2,5,6-tetrahydropyrrolo[3,2,1-ij]quinolin-4-one (GB 13 94 373);
proquinazid, 6-iodo-2-propoxy-3-propylquinazolin-4(3H)-one (WO 97/48684);
tricyclazole, 5-methyl-1,2,4-triazolo[3,4-b]benzothiazole (GB 14 19 121);
acibenzolar-S-methyl, methyl benzo[1,2,3]thiadiazole-7-carbothionate;
captafol, N-(1,1,2,2-tetrachloroethylthio)cyclohex-4-ene-1,2-dicarboximide;
captan, 2-trichloromethylsulfanyl-3a,4,7,7a-tetrahydroisoindole-1,3-dione (U.S. Pat. No. 2,553,770);
dazomet, 3,5-dimethyl-1,3,5-thiadiazinane-2-thione;
folpet, 2-trichloromethylsulfonylisoindole-1,3-dione (U.S. Pat. No. 2,553,770);
fenoxanil, N-(1-cyano-1,2-dimethylpropyl)-2-(2,4-dichlorophenoxy)propanamide (EP-A 262 393);
quinoxyfen, 5,7-dichloro-4-(4-fluorophenoxy)quinoline (U.S. Pat. No. 5,240,940);

The compounds without a common name, their preparation and their fungicidal action are likewise known:

5-chloro-7-(4-methylpiperidin-1-yl)-6-(2,4,6-trifluorophenyl)[1,2,4]triazolo[1,5-a]pyrimidine, (WO 98/46608)
2-butoxy-6-iodo-3-propylchromen-4-one (WO 03/14103);
N,N-dimethyl-3-(3-bromo-6-fluoro-2-methylindole-1-sulfonyl)[1,2,4]triazole-1-sulfonamide (WO 03/053145),

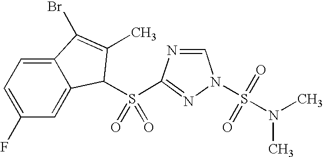

5-chloro-6-phenyl-7-heterocyclylaminotriazolopyrimidines of the formula II-A are known in a general manner from U.S. Pat. No. 5,593,996.

It was an object of the present inventions, with a view to reducing the application rates and broadening the activity spectrum of the known compounds, to provide mixtures which, at a reduced total amount of active compounds applied, have improved activity against harmful fungi, in particular for certain indications.

We have found that this object is achieved by the mixtures defined at the outset. Moreover, we have found that simultaneous, that is joint or separate, application of the compound I and an active compound II or successive application of the compound I and an active compound II allows better control of harmful fungi than is possible with the individual compounds (synergistic mixtures). The compound I can be used as a synergist for a large number of different active compounds. Simultaneous, that is joint or separate, application of the compound I with an active compound II increases the fungicidal activity in a superadditive manner.

The mixtures of the compound I and an active compound II or the simultaneous, that is joint or separate, use of the compound I and an active compound II are distinguished by being highly active against a wide range of phytopathogenic fungi, in particular from the classes of the Ascomycetes, Deuteromycetes, Oomycetes and Basidiomycetes. Some of them act systemically and can be used in crop protection as foliar- and soil-acting fungicides.

They are particularly important for controlling a multitude of fungi on various crop plants, such as bananas, cotton, vegetable species (for example cucumbers, beans and cucurbits), barley, grass, oats, coffee, potatoes, corn, fruit species, rice, rye, soybeans, tomatoes, grapevines, wheat, ornamental plants, sugar cane and on a large number of seeds.

They are advantageously suitable for the control of the following phytopathogenic fungi: Blumeria graminis (powdery mildew) on cereals, Erysiphe cichoracearum and Sphaerotheca fuliginea on cucurbits, Podosphaera leucotricha on apples, Uncinula Necator on grapevines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria species on wheat, Botrytis cinerea on strawberries, vegetables, ornamental plants and grapevines, Mycosphaerella species on bananas, peanuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grapevines, Altemaria species on fruit and vegetables and also Fusarium and Verticillium species.

The mixtures of the compound I and an active compound II are particularly suitable for controlling harmful fungi from the class of the Oomycetes.

The compound I and active compounds II can be applied simultaneously, that is jointly or separately, or in succession, the sequence, in the case of separate application, generally not having any effect on the result of the control measures.

If the mixtures according to the invention relate to compounds of the formula II-A, these are in particular the compounds of the formula II-A compiled in the table below where the groups D and L are as defined below:

TABLE 1

| Compound | | |
|---|---|---|
| No. | D | L |
| I-1 | —(CH₂)₄— | CH₃ |
| I-2 | —(CH₂)₄— | F |
| I-3 | —(CH₂)₄— | Cl |
| I-4 | —CH(CH₃)—CH₂—CH₂—CH₂— | CH₃ |
| I-5 | —CH(CH₃)—CH₂—CH₂—CH₂— | F |
| I-6 | —CH(CH₃)—CH₂—CH₂—CH₂— | Cl |
| I-7 | —CH₂—CH(CH₃)—CH₂—CH₂— | CH₃ |
| I-8 | —CH₂—CH(CH₃)—CH₂—CH₂— | F |
| I-9 | —CH₂—CH(CH₃)—CH₂—CH₂— | Cl |
| I-10 | —CH(CH₃)—CH(CH₃)—CH₂—CH₂— | CH₃ |
| I-11 | —CH(CH₃)—CH(CH₃)—CH₂—CH₂— | F |
| I-12 | —CH(CH₃)—CH(CH₃)—CH₂—CH₂— | Cl |
| I-13 | —CH(CH₃)—CH₂—CH(CH₃)—CH₂— | CH₃ |
| I-14 | —CH(CH₃)—CH₂—CH(CH₃)—CH₂— | F |
| I-15 | —CH(CH₃)—CH₂—CH(CH₃)—CH₂— | Cl |
| I-16 | —CH(CH₃)—CH₂—CH₂—CH(CH₃)— | CH₃ |
| I-17 | —CH(CH₃)—CH₂—CH₂—CH(CH₃)— | F |
| I-18 | —CH(CH₃)—CH₂—CH₂—CH(CH₃)— | Cl |
| I-19 | —(CH₂)₅— | CH₃ |
| I-20 | —(CH₂)₅— | F |
| I-21 | —(CH₂)₅— | Cl |
| I-22 | —CH(CH₃)—CH₂—CH₂—CH₂—CH₂— | CH₃ |
| I-23 | —CH(CH₃)—CH₂—CH₂—CH₂—CH₂— | F |
| I-24 | —CH(CH₃)—CH₂—CH₂—CH₂—CH₂— | Cl |
| I-25 | —CH₂CH(CH₃)—CH₂—CH₂—CH₂— | CH₃ |
| I-26 | —CH₂CH(CH₃)—CH₂—CH₂—CH₂— | F |
| I-27 | —CH₂CH(CH₃)—CH₂—CH₂—CH₂— | Cl |
| I-28 | —CH₂—CH₂—CH(CH₃)—CH₂—CH₂— | CH₃ |
| I-29 | —CH₂—CH₂—CH(CH₃)—CH₂—CH₂— | F |
| I-30 | —CH₂—CH₂—CH(CH₃)—CH₂—CH₂— | Cl |
| I-31 | —CH(CH₃)—CH(CH₃)—CH₂—CH₂—CH₂— | CH₃ |
| I-32 | —CH(CH₃)—CH(CH₃)—CH₂—CH₂—CH₂— | F |
| I-33 | —CH(CH₃)—CH(CH₃)—CH₂—CH₂—CH₂— | Cl |
| I-34 | —CH(CH₃)—CH₂—CH(CH₃)—CH₂—CH₂— | CH₃ |
| I-35 | —CH(CH₃)—CH₂—CH(CH₃)—CH₂—CH₂— | F |
| I-36 | —CH(CH₃)—CH₂—CH(CH₃)—CH₂—CH₂— | Cl |
| I-37 | —CH(CH₃)—CH₂—CH₂—CH(CH₃)—CH₂— | CH₃ |
| I-38 | —CH(CH₃)—CH₂—CH₂—CH(CH₃)—CH₂— | F |
| I-39 | —CH(CH₃)—CH₂—CH₂—CH(CH₃)—CH₂— | Cl |
| I-40 | —CH(CH₃)—CH₂—CH₂—CH₂—CH(CH₃)— | CH₃ |
| I-41 | —CH(CH₃)—CH₂—CH₂—CH₂—CH(CH₃)— | F |
| I-42 | —CH(CH₃)—CH₂—CH₂—CH₂—CH(CH₃)— | Cl |
| I-43 | —CH(CH₂CH₃)—CH₂—CH₂—CH₂—CH₂— | CH₃ |
| I-44 | —CH(CH₂CH₃)—CH₂—CH₂—CH₂—CH₂— | F |
| I-45 | —CH(CH₂CH₃)—CH₂—CH₂—CH₂—CH₂— | Cl |
| I-46 | —CH—CH(CH₂CH₃)—CH₂—CH₂—CH₂— | CH₃ |
| I-47 | —CH—CH(CH₂CH₃)—CH₂—CH₂—CH₂— | F |
| I-48 | —CH—CH(CH₂CH₃)—CH₂—CH₂—CH₂— | Cl |
| I-49 | —CH₂—CH₂—CH(CH₂CH₃)—CH₂—CH₂— | CH₃ |
| I-50 | —CH₂—CH₂—CH(CH₂CH₃)—CH₂—CH₂— | F |
| I-51 | —CH₂—CH₂—CH(CH₂CH₃)—CH₂—CH₂— | Cl |
| I-52 | —CH₂—CH₂—CH(CH₂CH₂CH₃)—CH₂—CH₂— | CH₃ |
| I-53 | —CH₂—CH₂—CH(CH₂CH₂CH₃)—CH₂—CH₂— | F |
| I-54 | —CH₂—CH₂—CH(CH₂CH₂CH₃)—CH₂—CH₂— | Cl |
| I-55 | —CH₂—CH₂—CH(C[CH₃]₃)—CH₂—CH₂— | CH₃ |
| I-56 | —CH₂—CH₂—CH(C[CH₃]₃)—CH₂—CH₂— | F |
| I-57 | —CH₂—CH₂—CH(C[CH₃]₃)—CH₂—CH₂— | Cl |
| I-58 | —(CH₂)₆— | CH₃ |
| I-59 | —(CH₂)₆— | F |
| I-60 | —(CH₂)₆— | Cl |

The invention preferably provides mixtures comprising compounds of the formula II-A in which L is methyl and D has one of the following meanings:

—(CH₂)₄—; —CH₂—CH(CH₃)—CH₂—CH₂—; —CH(CH₃)—CH(CH₃)—CH₂—CH₂—; —CH(CH₃)—CH₂—CH(CH₃)—CH₂—; —(CH₂)₅—; —CH(CH₃)—CH₂—CH₂—CH₂—CH₂—; —CH(CH₃)—CH₂—CH₂—CH(CH₃)—; —CH₂—CH₂—CH(CH₃)—CH₂—CH₂—; —CH(CH₃)—CH(CH₃)—CH₂—CH₂—CH₂—; —CH(CH₃)—CH₂—CH(CH₃)—CH₂—CH₂—; —CH(CH₃)—CH₂—CH₂—CH(CH₃)—CH₂—; —CH(CH₃)—CH₂—CH₂—CH₂—CH(CH₃)—; —CH(CH₂CH₃)—CH₂—CH₂—CH₂—CH₂—; —CH—CH(CH₂CH₃)—CH₂—CH₂—CH₂—; —CH₂—CH₂—CH(CH₂CH₃)—CH₂—CH₂—; —CH₂—CH₂—CH(CH₂CH₂CH₃)—CH₂—CH₂—; —CH₂—CH₂—CH(C[CH₃]₃)—CH₂—CH₂— and —(CH₂)₆—.

In addition, preference is also given to mixtures with compounds of the formula II-A in which L is fluorine and D has one of the following meanings:

—(CH₂)₄—; —CH₂—CH(CH₃)—CH₂—CH₂—; —CH(CH₃)—CH(CH₃)—CH₂—CH₂—; —CH(CH₃)—CH₂—CH(CH₃)—CH₂—; —CH(CH₃)—CH₂—CH₂—CH(CH₃)—; —CH₂CH(CH₃)—CH₂—CH₂—CH₂—; —CH₂—CH₂—CH(CH₃)—CH₂—CH₂—; —CH(CH₃)—CH(CH₃)—CH₂—CH₂—CH₂—; —CH(CH₃)—CH₂—CH(CH₃)—CH₂—CH₂—; —CH(CH₃)—CH₂—CH₂—CH(CH₃)—CH₂—; —CH(CH₃)—CH₂—CH₂—CH₂—CH(CH₃)—; —CH(CH₂CH₃)—CH₂—CH₂—CH₂—CH₂—; —CH—CH(CH₂CH₃)—CH₂—CH₂—CH₂—; —CH₂—CH₂—CH(CH₂CH₃)—CH₂—CH₂—; —CH₂—CH₂—CH(CH₂CH₂CH₃)—CH₂—CH₂— and —CH₂—CH₂—CH(C[CH₃]₃)—CH₂—CH₂—.

In addition, preference is also given to mixtures with compounds of the formula II-A in which L is chlorine and D has one of the following meanings:

—CH(CH₃)—CH(CH₃)—CH₂—CH₂—; —CH₂—CH(CH₃)—CH₂—CH₂—; —CH(CH₃)—CH₂—CH(CH₃)—CH₂—; —CH(CH₃)—CH₂—CH₂—CH(CH₃)—; —CH₂CH(CH₃)—CH₂—CH₂—CH₂—; —CH(CH₃)—CH(CH₃)—CH₂—CH₂—CH₂—; —CH(CH₃)—CH₂—CH₂—CH(CH₃)—CH₂—; —CH(CH₃)—CH₂—CH₂—CH₂—CH(CH₃)—; —CH(CH₂CH₃)—CH₂—CH₂—CH₂—CH₂—; —CH—CH(CH₂CH₃)—CH₂—CH₂—CH₂—; —CH₂—CH₂—CH(CH₂CH₃)—CH₂—CH₂—; —CH₂—CH₂—CH(CH₂CH₂CH₃)—CH₂—CH₂- and —CH₂—CH₂—CH(C[CH₃]₃)—CH₂—CH₂—.

When preparing the mixtures, it is preferred to employ the pure active compounds, to which further active compounds against harmful fungi or against other pests, such as insects, arachnids or nematodes, or else herbicidal or growth-regulating active compounds or fertilizers can be added as further active components according to need.

What are usually used are mixtures of the compound I with one active compound II. However, in certain cases, mixtures of the compound I with two or, if appropriate, a plurality of active components may be advantageous.

Suitable further active components in the above sense are in particular the active compounds II mentioned at the outset and especially the preferred active compounds mentioned above.

The compound I and the active compound II are usually applied in a weight ratio of from 100:1 to 1:100, preferably from 20:1 to 1:20, in particular from 10:1 to 1:10.

The further active components are, if desired, added in a ratio of from 20:1 to 1:20 to the compound I.

Depending on the type of compound and the desired effect, the application rates of the mixtures according to the invention are from 5 g/ha to 2000 g/ha, preferably from 50 to 900 g/ha, in particular from 50 to 750 g/ha.

Correspondingly, the application rates for the compound I are generally from 1 to 1000 g/ha, preferably from 10 to 900 g/ha, in particular from 20 to 750 g/ha.

Correspondingly, the application rates for the active compound II are generally from 1 to 2000 g/ha, preferably from 10 to 900 g/ha, in particular from 40 to 500 g/ha.

In the treatment of seed, application rates of mixture are generally from 1 to 1000 g/100 kg of seed, preferably from 1 to 750 g/100 kg, in particular from 5 to 500 g/100 kg.

The method for controlling harmful fungi is carried out by the separate or joint application of the compound I and the active compound II or of the mixtures of the compound I and the active compound II by spraying or dusting the seeds, the plants or the soils before or after sowing of the plants or before or after emergence of the plants.

The mixtures according to the invention, or the compound I and the active compound II, can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable for use as surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

For seed treatment, the formulations in question give, after two- to ten-fold dilution, active compound concentrations of from 0.01 to 60% by weight, preferably from 0.1 to 40% by weight, in the ready-to-use preparations.

The following are examples of formulations of the invention:
1. Products for Dilution with Water

### A Water-Soluble Concentrates (SL, LS)

10 parts by weight of the active compounds are dissolved with 90 parts by weight of water or a water-soluble solvent. As an alternative, wetters or other auxiliaries are added. The active compound dissolves upon dilution with water. In this way, a formulation having an active compound content of 10% by weight is obtained.

### B Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion. The active compound content is 20% by weight.

### C Emulsifiable Concentrates (EC)

15 parts by weight of the active compounds are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

### D Emulsions (EW, EO, ES)

25 parts by weight of the active compounds are dissolved in 35 parts by weight of xylene with addition of calcium dodecylbenzenesulfonate and castor oil ethoxylate (in each case 5 parts by weight). This mixture is added to 30 parts by weight of water by means of an emulsifying machine (for example Ultraturrax) and made into a homogeneous emulsion. Dilution with water gives an emulsion. The formulation has an active compound content of 25% by weight.

### E Suspensions (SC, OD, FS)

In an agitated ball mill, 20 parts by weight of the active compounds are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

### F Water-Dispersible Granules and Water-Soluble Granules (WG, SG)

50 parts by weight of the active compounds are ground finely with addition of 50 parts by weight of dispersants and wetters and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

### G Water-Dispersible Powders and Water-Soluble Powders (WP, SP, SS, WS)

75 parts by weight of the active compounds are ground in a rotor-stator mill with addition of 25 parts by weight of dispersants, wetters and silica gel. Dilution with water gives a stable dispersion or solution of the active compound. The active compound content of the formulation is 75% by weight.

### H Gel Formulations

In a bead mill, 20 parts by weight of the active compounds, 10 parts by weight of dispersant, 1 part by weight of gelling agent and 70 parts by weight of water or an organic solvent are ground to give a fine suspension. Dilution with water gives a stable suspension having an active compound content of 20% by weight.
2. Products to be Applied Undiluted

### I Dusts (DP, DS)

5 parts by weight of the active compounds are ground finely and mixed intimately with 95 parts by weight of finely divided kaolin. This gives a dustable product having an active compound content of 5% by weight.

### J Granules (GR, FG, GG, MG)

0.5 part by weight of the active compounds is ground finely and associated with 99.5 parts by weight of carriers. Current methods are extrusion, spray-drying or the fluidized bed. This gives granules to be applied undiluted having an active compound content of 0.5% by weight.

### K ULV Solutions (UL)

10 parts by weight of the active compounds are dissolved in 90 parts by weight of an organic solvent, for example xylene. This gives a product to be applied undiluted having an active compound content of 10% by weight.

For seed treatment, it is customary to employ water-soluble concentrates (LS), suspensions (FS), dusts (DS), water-dispersible and water-soluble powders (WS, SS), emulsions (ES), emulsifiable concentrates (EC) and gel formulations (GF). These formulations can be applied to the seed undiluted or, preferably, diluted. Application can be prior to sowing.

Preference is given to using FS formulations for seed treatment. Usually, such formulations comprise from 1 to 800 g of active compound/l, from 1 to 200 g of surfactants/l, from 0 to 200 g of antifreeze agents/l, from 0 to 400 g of binders/l, from 0 to 200 g of colorants/l and solvents, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds even, if appropriate, not until immediately prior to use (tank mix). These agents may be admixed with the compositions according to the invention in a weight ratio of from 1:100 to 100:1, preferably from 1:10 to 10:1.

Suitable adjuvants in this context are in particular: organic modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodiumdioctylsulfosuccinate, for example Leophen RA®.

The compounds I and II or the mixtures or the corresponding formulations are applied by treating the harmful fungi, the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal effect of the compound and the mixtures can be demonstrated by the following tests:

### Active Compound Preparation

For the microtiter tests, the active compounds were formulated separately as a stock solution having a concentration of 10 000 ppm in DMSO. The active compound fluazinam was used as a commercial formulation and pre-diluted with water to the stock solution concentration of 10 000 ppm.

The active compounds were prepared separately or jointly as a stock solution with 25 mg of active compound which was made up to 10 ml using a mixture of acetone and/or DMSO and the emulsifier Uniperol® EL (wetting agent having emulsifying and dispersing action based on ethoxylated alkylphenols) in a volume ratio of solvent/emulsifier of 99 to 1. The mixture was then made up with water to 100 ml. This stock solution was diluted with the solvent/emulsifier/water mixture described to the concentration of active compounds stated beldw. The active compound fluazinam was used as a commercial formulation and diluted with water to the stated concentration.

### Evaluation

In the microtiter tests, the measured parameters were compared to the growth of the active compound-free control variant and the fungus- and active compound-free blank value to determine the relative growth in % of the pathogens in the individual active compounds.

In the greenhouse tests, the visually determined percentages of infected leaf areas were converted into efficacies in % of the untreated control:

The efficacy (E) is calculated as follows using Abbot's formula:

E=(1−α/β)·100

α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants are not infected.

The expected efficacies of combinations of active compounds were determined using Colby's formula (Colby, S. R. “Calculating synergistic and antagonistic responses of herbicide combinations”, Weeds, 15, 20-22, 1967) and compared with the observed efficacies.

Colby's formula:

E=x+y−x·y/100
E expected efficacy, expressed in % of the untreated control, when using the mixture of the active compounds A and B at the concentrations a and b
x efficacy, 'expressed in % of the untreated control, when using the active compound A at the concentration a
y efficacy, expressed in % of the untreated control, when using the active compound B at the concentration b

### USE EXAMPLE 1

### Activity Against the Gray Mold Pathogen Botrytis Cinerea in the Microtiter Test

The stock solutions were mixed to give the required ratio, pipetted into a microtiter plate (MTP) and diluted with an aqueous malt-based fungus nutrient medium to the stated active compound concentration. An aqueous spore suspension of Botrytis cinerea was then added. The plates were placed in a water vapor-saturated chamber at temperatures of 18° C. On day 7 after the inoculation, the MTPs were measured in an absorption photometer at 405 nm.

The measured parameters were compared to the growth of the active compound-free control variant and the fungus- and active compound-free blank value to determine the relative growth in % of the pathogens in the individual active compounds.

| | | | | | Calculated |
|---|---|---|---|---|---|
| | | | | Observed | efficacy |
| | Active | Conc. | | efficacy | according to |
| No. | compound | [ppm] | Ratio | (%) | Colby (%) |
| 1 | enestroburin (I) | 0.25 | | 0 | |
| | | 0.125 | | 0 | |
| | | 0.063 | | 0 | |
| 2 | fluazinam | 0.063 | | 35 | |
| | (II-1) | | | | |
| 3 | pyrimethanil | 0.125 | | 70 | |
| | (II-9) | | | | |
| 4 | I + II-1 | 0.063 + 0.063 | 1:1 | 78 | 35 |
| 5 | I + II-1 | 0.25 + 0.063 | 4:1 | 85 | 35 |
| 6 | I + II-9 | 0.125 + 0.125 | 1:1 | 87 | 70 |

### USE EXAMPLE 2

### Activity Against Late Blight on Tomatoes Caused by Phytophthora Infestans Protective Treatment

Leaves of potted tomato plants were sprayed to run off point with an aqueous suspension having the concentration of active compound stated below. After 5 days, the leaves were infected with an aqueous sporangia suspension of Phytophthora infestans. The plants were then placed in a water vapor-saturated chamber at temperatures between 18 and 20° C. After 6 days, the late blight on the untreated but infected control plants had developed to such an extent that the infection could be determined visually in %.

| | | | | | Calculated |
|---|---|---|---|---|---|
| | | | | | efficacy |
| | Active | Conc. | | Observed efficacy | according to |
| No. | compound | [ppm] | Ratio | (%) | Colby (%) |
| 7 | —(control) | — | | 0 (90% infection) | |
| 8 | enestroburin (I) | 63 | | 11 | |
| 9 | fluazinam | 16 | | 22 | |
| | (II-1) | | | | |
| 10 | I + II-1 | 63 + 63 | 1:1 | 56 | 31 |

The test results show that, by virtue of the synergism, the mixtures according to the invention are considerably more active than had been predicted using Colby's formula.

1-9. (canceled)

10. A fungicidal mixture for controlling phytopathogenic harmful fungi, which mixture comprises two active components:
1) the strobilurin derivative of the formula I, 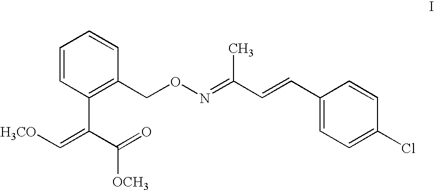
and
2) at least one active compound II selected from the group of heterocyclic compounds:
fluazinam, pyrifenox,
bupirimate, cyprodinil, fenarimol, ferimzone, mepanipyrim, nuarimol,
pyrimethanil,
triforine,
fenpiclonil, fludioxonil,
aldimorph, dodemorph, fenpropimorph, tridemorph,
fenpropidin,
iprodione, procymidone, vinclozolin,
famoxadone, fenamidone, octhilinone, probenazole,
5-chloro-7-(4-methylpiperidin-1-yl)-6-(2,4,6-trifluorophenyl)[1,2,4]triazolo[1,5-a]pyrimidine,
anilazine, diclomezine, pyroquilon, proquinazid, tricyclazole,
2-butoxy-6-iodo-3-propylchromen-4-one,
acibenzolar-S-methyl, captafol, captan, dazomet, folpet, fenoxanil, quinoxyfen,
N,N-dimethyl-3-(3-bromo-6-fluoro-2-methylindol-1-sulfonyl)[1,2,4]triazole-1-sulfonamide,
5-chloro-6-phenyl-7-heterocyclylaminotriazolopyrimidines of the formula II-A, 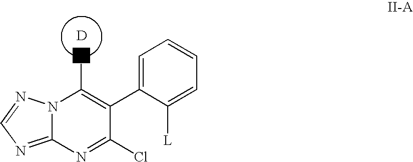
in which
D together with the nitrogen atom forms a pyrrolidine, piperidine or azepine ring, which rings are unsubstituted or substituted by one or two methyl groups or by one ethyl, propyl or butyl group; and
L is methyl, fluorine or chlorine;
in a synergistically effective amount.

11. The fungicidal mixture according to claim 10 which comprises the compound of the formula I and an active compound II in a weight ratio of from 100:1 to 1:100.

12. A composition comprising a liquid or solid carrier and a mixture according to claim 10.

13. A method for controlling phytopathogenic harmful fungi which comprises treating the fungi, their habitat or the seed, the soil or the plants to be protected against fungal attack with an effective amount of the compound I and an active compound II according to claim 10.

14. The method according to claim 13, wherein the compounds I and II are applied simultaneously, that is jointly or separately, or in succession.

15. The method according to claim 13, wherein the compounds I and II are applied in an amount of from 5 g/ha to 2000 g/ha.

16. The method according to claim 13, wherein the compounds I and II are applied in an amount of from 1 to 1000 g/100 kg of seed.

17. Seed comprising the mixture according to claim 10 in an amount of from 1 to 1000 g/100 kg.

18. The use of the compounds I and II according to claim 10 for preparing a composition suitable for controlling harmful fungi.
